(19) United States
(12) Patent Application Publication
(10) Pub. No.: US 2003/0166387 A1
(43) Pub. Date: Sep. 4, 2003

(54) Abrasive article with hydrophilic/lipophilic coating

(75) Inventors: Pei-Jung Chen, London (CA); Robert F. Smith, London (CA); Wei Gang Huang, London (CA)

Correspondence Address: Attention: Gregory D. Allen, Office of Intellectual Property Counsel, 3M Innovative Properties Company, P.O. Box 33427, St. Paul, MN, 55133-3427, US

(73) Assignee: 3M Innovative Properties Company

(21) Appl. No.: 10/342,648

(22) Filed: Jan. 15, 2003

(30) Foreign Application Priority Data
Jan. 15, 2002 (CA) 2,367,812

(51) Int. Cl. C09K 3/14; B24D 11/00

(52) U.S. Cl. 451/533; 51/298

(57) ABSTRACT

An abrasive article comprising a backing material having first and second opposed major surfaces and an abrasive layer comprising abrasive particles and binder secured to the said first major surface, the article also bearing a hydrophilic/lipophilic urethane material to enhance dimensional and conformational stability of the abrasive article.

This Application claims priority from Canadian Patent Application No. 2,367,812, filed Jan. 15, 2002.

### FIELD OF INVENTION

The present invention relates to flexible abrasive materials that have enhanced dimensional and conformational stability.

### BACKGROUND OF THE INVENTION

There are known flexible abrasive materials that are composed of a flexible backing sheet on one or both surfaces of which grains of abrasive material are held by a binder. The backing sheet can be for example, made of a cellulosic material such as paper, or it may be cloth, woven or non-woven and made of natural or synthetic fibre such as polyester. These can be treated in various known ways for particular purposes, for instance fibre can be vulcanised. Abrasive grains can be formed of flint, garnet, aluminium oxide, ceramic aluminium oxide, alumina, zirconia, diamond, silicon, carbide or other materials known in this art. The abrasive article is normally a flat i.e., planar, sheet, and for many purposes it is desirable that it shall remain flat, or planar during use as an abrasive. In practice, however, cupping or curling may occur.

Curling and cupping are undesirable for a variety of reasons. Often the abrasive material is in the form of a belt that is to run on a track or around rollers. Lack of dimensional stability can cause the abrasive material to wander or depart from its intended track, with unintended and undesired consequences. In some instances the abrasive material may cup, so that only the edges of the abrasive belt contact the object or workpiece that is being subjected to abrasion. Hence, the edges of the abrasive belt wear out while the centre of the belt remains pristine and unused. Cupping can also adversely affect the workpiece, as abrasion occurs only at those parts of the workpiece that are in contact with the edges of the belt, and material that should be abraded by the center of the belt is not contacted by the belt, or is contacted with less pressure than at the edges, so that abrasion occurs slowly or not at all. Hence undesired grooves can form in the workpiece. Furthermore, if the workpiece is glass there can form stress areas where contact with edges of the abrasive belt has occurred. It is possible that these stress areas will cause failure of the glass, which of course destroys the workpiece and can be dangerous. It is therefore desirable that abrasive articles shall have good dimensional stability.

### SUMMARY OF THE INVENTION

In one aspect, the invention provides an abrasive article comprising a backing material having first and second opposed major surfaces and an abrasive layer comprising abrasive particles and binder secured to the said first major surface, the article also bearing a hydrophilic/lipophilic urethane material to enhance dimensional and conformational stability of the abrasive article, wherein the hydrophilic/lipophilic urethane material is selected from the group consisting of:

a) products of reaction of a polyisocyanate, a polyethylene oxide and a long chain aliphatic alcohol, in admixture with a polymer derived from acrylic acid or an α- or β-substituted acrylic acid, and

b) polymers with an ethylene-containing backbone bearing urethane-linked nitrogen-bonded hydrocarbon groups and oxygen-linked water solubilizing groups.

The hydrophilic/lipophilic urethane material can be used to treat a pre-existing abrasive article, thus forming an external layer on the surfaces to which it is applied.

In another aspect, the invention provides a process for preparing a coated abrasive article which comprises applying, for example, by roll coating, spraying, brushing, or casting, a hydrophilic/lipophilic urethane material onto a major surface of an abrasive article to form the coated abrasive article, wherein the urethane material is selected from the group consisting of:

a) products of reaction of a polyisocyanate, a polyethylene oxide and a long chain aliphatic alcohol, in admixture with a polymer derived from acrylic acid or an α- or β-substituted acrylic acid, and

b) a co-polymer with an ethylene-containing backbone, bearing urethane-linked nitrogen-bonded hydrocarbon groups and oxygen-linked water solubilizing groups.

Particular mention is made of abrading glass with an abrasive article. This is normally done under a flood of water, to wash away swarf and to remove frictional heat. The presence of a large amount of water exacerbates any tendency to dimensional or conformational instability. The treated abrasive article of the invention is particularly advantageous for use in abrading glass, owing to its enhanced dimensional and conformational stability during use.

### DESCRIPTION OF PREFERRED EMBODIMENTS

The abrasive article that is treated with the urethane material can be a known abrasive article, including any commercially available abrasive article. Thus, the backing can be any of the flexible materials known for this purpose, including cellulosic materials such as paper, and cloth woven or non-woven. If cloth, the fibers may be natural or synthetic, for example polyester. The abrasive particles or grains may be, for example, flint, garnet, aluminium oxide, ceramic aluminium oxide, alumina, silica, zirconia, diamond, silicon carbide, emery, quartz, pumice, pulverised glass, or kieselguhr. The abrasive grains are held by binders in a manner such that a substantial part of each grain is exposed and available to perform the required abrading action. As binders there are commonly used phenolic resins, hide glue, urea-formaldehyde resins, urethane resins, epoxy resins and varnish. Usually abrasive grains are present on only one of the major surfaces of the backing (the first surface) but for some purposes abrasive articles having abrasive grains on both major surfaces are useful, and such articles are within the scope of the invention. The abrasive layer may comprise abrasive grains adhered to a first cured binder, or make coat, as described in U.S. Pat. No. 4,751,138 (Tumey et al), or a three-dimensionally shaped abrasive composite, wherein abrasive grains are uniformly dispersed in a binder, as described in U.S. Pat. No. 5,942,015 (Culler-et al.), each of these patents is incorporated herein by reference.

It is of course known to classify abrasive articles by the size of the abrasive grains and the grains of the article of the invention are preferably classified in the known classification system The size of the grains preferably ranges from 25 μm (P800 grit) to 500 μm (P36 grit) in size. More preferably, the grain size ranges from 100 μm (P150 grit) to 200 μm (P80 grit).

### Application Methods

The urethane material can be applied to either the abrasive layer on the first major surface or to the second major surface of the backing material, or to both. According to one embodiment of the invention, the urethane material is only applied to the second major surface, that is the surface not supporting abrasive particles. Application can be effected by any of the usual methods such as, for example, brushing, casting, spraying or rolling. For brushing, casting or spraying the material may be present in solution, dispersion or suspension in a liquid vehicle, preferably water, together with any required surfactants, suspension agents and the like. For spraying the material may be in a liquid vehicle such as hexane or ethyl acetate, and it may be in an aerosol spray with a suitable propellant, for example, dimethyl ether. The treated abrasive article can then be allowed to air dry, or it can be subjected to an artificial drying process. For example, sheets of the abrasive article can be passed over steam cans, cylindrical metal cans that bear a felt liner on their outer cylindrical surface and to whose interior steam is supplied. The heat drives off water, and the felt provides space between the metal surface of the can and the surface of the material being dried, into which space water can evaporate.

### Lone Chain Alcohol/Ethylene Oxide Urethanes

One class of suitable urethanes is prepared by reacting a polyisocyanate, a polyethylene oxide containing at least one hydroxy group, and a long chain aliphatic alcohol.

Suitable polyisocyanates include diisocyanates, triisocyanates, and mixtures thereof. Preferably, the polyisocyanate is a triisocyanate. The polyisocyanate includes aliphatic, alicyclic, araliphatic, or aromatic compounds that may be used either singly or in a mixture of two or more. Suitable aromatic polyisocyanates include, for example, 2,4-toluene diisocyanate (TDI), 2,6-toluene diisocyanate, an adduct of TDI with trimethylolpropane (available as DESMODUR™ CB from Bayer Corporation, Pittsburgh, Pa.), the isocyanurate trimer of TDI (available as DESMODUR™ IL from Bayer Corporation), diphenylmethane 4,4′-diisocyanate (MDI), diphenylmethane 2,4′-diisocyanate, 1,5-diisocyanato naphthalene, 1,4-phenylene diisocyanate, 1,3-phenylene diisocyanate, 1-methoxy-2,4-phenylene diisocyanate, 1-chlorophenyl-2,4-diisocyanate, and mixtures thereof.

Alicyclic polyfunctional isocyanate compounds include, for example, bis(4-isocyanatocyclohexyl)methane (H₁₂MDI, available as DESMODUR™ W from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), 1,3-bis(isocyanatomethyl)cyclohexane (H₆XDI), 3-isocyanatomethyl-3,5,5-trimethylcyclohexyl isocyanate (available as DESMODUR™ I from Bayer Corporation), and mixtures thereof.

Aliphatic polyfunctional isocyanate compounds include, for example, tetramethylene 1,4-diisocyanate, hexamethylene 1,4-diisocyanate, hexamethylene 1,6-diisocyanate (HDI, available as DESMODUR™ H from Bayer Corporation), octamethylene 1,8-diisocyanate, 1,12-dilsocyanatododecane, 2,2,4-trimethylhexamethylene diisocyanate (TMDI), 2-methyl-1,5-pentamethylene diisocyanate, dimer diisocyanate, the urea of hexamethylene diisocyanate (HDI), the biuret of hexamethylene 1,6-diisocyanate (HDI) (available as DESMODUR™ N-100 and N-3200 from Bayer Corporation, Pittsburgh, Pa.), the isocyanurate of HDI (available as DESMODUR™ N-3300 and DESMODUR™ N-3600 from Bayer Corporation), a blend of the isocyanurate of HDI and the uretdione of HDI (available as DESMODUR™ N-3400 available from Bayer Corporation), and mixtures thereof

Araliphatic polyisocyanates include, but are not limited to, those selected from the group consisting of m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof.

The long chain alcohol used to prepare the urethane comprises a hydroxy group and a long straight or branched chain aliphatic group containing at least 8 and typically from about 12 to about 24, preferably from about 14 to 20 carbon atoms, and more preferably 18 carbon atoms. The alcohol is typically hydrophobic or lipophilic and not soluble in water. Long chain hydrocarbon alcohols include stearyl alcohol (C₁₈H₃₇OH), cetyl alcohol (C₁₆H₃₃OH), myristyl alcohol (C₁₄H₂₉OH), and the like. Mixtures of the long chain alcohols can be used. Such alcohols are available from Condea Vista Co. (Houston, Tex.) and from Sigma Aldrich Chemical Co. (Milwaukee, Wis.). The long chain portion of the alcohol is typically a hydrocarbon but can include one or more heteroatoms such as oxygen, sulfur or nitrogen interrupting the carbon chain that do not provide additional sites capable of reacting with a polyisocyanate. Examples include esters, ethers, additional sites capable of reacting with a polyisocyanate. Examples include esters, ethers, substituted amines, and the like. One preferred example of a long chain alcohol is stearyl alcohol.

The polyethylene oxide used to prepare the urethane typically contains from about 1 to about 200 ethylene oxide units and has at least one hydroxy group capable of reacting with an isocyanate. The polyethylene oxide can bear two hydroxy groups, in the terminal postitions, but preferably, the polyethylene oxide is monofunctional with the other end of the polymer capped with a (C₁ to C₂₄) alkoxy group such as methoxy, ethoxy, stearoxy, myristoxy, and the like. Examples of polyethylene oxide containing only one hydroxy group per molecule include methoxy-capped polyethylene oxides such as CARBOWAX™ 350 (PEO with molecular weight of 350), CARBOWAX™ 550 (PEO with molecular weight of 550), CARBOWAX™ 750 (PEO with molecular weight of 750) and CARBOWAX™ 2000 (PEO with molecular weight of 2000), available from Dow Chemical Company, Midland, Mich. Other suitable polymers include ethoxylated alcohols such as TOMADOL™ 45-13 (a polymer containing 13 ethylene oxide units reacted with a linear C₁₄-C₁₅ alcohol), TOMADOL™ 25-12 (a polymer containing 12 ethylene oxide units reacted with a linear C₁₂-C₁₅ alcohol) and TOMADOL™ 1-9 (a polymer containing 9 ethylene oxide units reacted with a linear C₁₁ alcohol), available from Tomah Products, Milton, Wis. Ethoxylated alkyl phenols such as, for example, TRITON™ X-100, TRITON™ X-102, and TRITON™ X-165 (available from Dow Chemical Company, Midland, Mich.) can also be used as the polyethylene oxide. A monofunctional polyethylene oxide can be combined with a polyethylene oxide diol such as, for example, CARBOWAX™ 1450 (a PEO diol with molecular weight of 1450) available from Dow Chemical Company, Midland, Mich.

The urethane of this embodiment typically has a polyethylene oxide content in the range of about 5 to about 55 weight percent based on the weight of the urethane. Preferably, the polyethylene oxide content is between about 10 to about 40 weight percent and more preferably between about 20 to about 35 weight percent based on the weight of the urethane. The polyethylene oxide group typically imparts hydrophilic characteristics to the urethane. If the content of polyethylene oxide is sufficiently high, the urethanes can be self-emulsified in water.

The polyisocyanate, polyethylene oxide, and long chain alcohol can be reacted using a standard urethane catalyst such as, for example, organo-tin compounds, organo-zirconium compounds, tertiary amines, strong bases, and ammonium salts. If the reaction temperature is sufficiently high, no catalyst is needed.

Organo-tin catalysts include dibutyltin dilaurate, dibutylbis(laurylthio)stannate, dibutyltinbis(isooctylmercaptoacetate), dibutyltinbis(isooctylmaleate), and the like. Organo-zirconium compounds include, for example, zirconium chelates such as K-KAT™ 4205, K-KAT™ XC-6212, K-KAT™ XC-9213 and K-KAT™ XC-A209 from King Industries, Norwalk, Conn. Tertiary amines include, for example, 2,4,6-tris(N,N-dimethylaminomethyl)-phenol, 1,3,5-tris(dimethylaminopropyl)hexahydro-s-triazine (Dabco), pentamethyldipropylenetriamine, bis(dimethylarmino ethyl ether), pentamethyldiethylenetriamine, dimethylcyclohexylamine, and the ammonium salts of these compounds. Strong bases include potassium acetate, potassium 2-ethylhexanoate, amine-epoxide combinations, and the like.

The reaction to form a urethane can be completed either in the absence of a solvent or in the presence of an aprotic solvent such as n-butyl acetate, toluene, methyl isobutyl ketone, and the like. Mixtures of aprotic solvents can be used. The urethane can be prepared by initially reacting either the polyethylene oxide or the long chain alcohol with the polyisocyanate followed by the addition of the other reactant. Alternatively, the polyethylene oxide and long chain alcohol can be placed in the reaction vessel with the polyisocyanate at the same time. Preferably, the polyethylene oxide and the long chain alcohol are first mixed with the solvent. Any water present in the mixture is azeotropically removed before the addition of the polyisocyanate.

The urethanes of this embodiment typically have a weighted average hydrophilic/lipophilic balance (“HLB”) between about 1 and about 11. As used herein, the term “HLB value” means the hydrophilic/lipophilic balance of each component of the urethane. The term “weighted average HLB value” is defined as the sum of the HLB values of each separate component multiplied by that component's percentage by weight in the urethane. HLB values can be calculated experimentally from partitioning the component between an aliphatic hydrocarbon solvent and water. Alternatively, HLB values can be calculated theoretically based on the structure of the compound by summing empirically derived group numbers for each portion of the structure. For molecules containing polyethylene oxide, the weighted average HLB value can be calculated by dividing the weight percent polyethylene oxide by 5.

The HLB of a mixture of urethanes is calculated as a colligative property. Thus, the HLB of the mixture is the weighted average of the HLB value for all the urethanes in the finishing composition.

Σ(HLBNₙ×Fₙ)=HLB_{weighted average}

HLBₙ is the HLB value of a given urethane and Fₙ is the weight fraction of that urethane based on the total weight of all the urethanes in the composition. For example, if the finishing composition contains 70 wt. % urethane 1 with a HLB value of 10 at and 30 wt. % urethane 2 with a HLB value of 5, the weighted average HLB value is 8.5.

(10×0.7)+(5×0.3)=7+1.5=8.5

Compounds with lower HLB values are relatively hydrophobic or lipophilic and have lower water solubility. Such compounds typically have longer hydrocarbon chains and/or a lower degree of ethoxylation. Conversely, components with higher HLB values are relatively hydrophilic and have higher water solubility. Such compounds typically have shorter hydrocarbon chains and/or a higher degree of ethoxylation. For detailed information concerning HLB values and the determination of HLB values, see Schick, Martin J., Nonionic Surfactants, Physical Chemistry, 23, 438-456 (1987). For a listing of commercially available hydrocarbon nonionic surfactants and their corresponding HLB values, see 2000 McCutcheon's, Vol. 1: Emulsifiers and Detergents, North American and International Editions, The Manufacturing Confectioner Publishing Co. (2000).

The weighted average HLB value is typically in the range of about 1 to about 11, preferably in the range of about 2 to about 8, and more preferably in the range of about 4 to about 7. When the weighted average HLB value is less than 2, the urethane composition generally forms droplets on the abrasive article. In contrast, when the weighted average HLB is in the range of about 3 to about 11, the urethane composition dries to form a film on the abrasive article. The water repellency of the finishing composition typically decreases when the weighted average HLB is greater than about 6.

The weighted average HLB value is typically in the range of about 1 to about 11, preferably in the range of about 2 to about 8, and more preferably in the range of about 4 to about 7. To obtain weighted average HLB values in this range, the urethane typically contains one or more long chain aliphatic groups that have hydrophobic or lipophilic properties. These long chain groups can be part of the polyethylene oxide or can be incorporated into the urethane structure through a functional group having an active hydrogen capable of reacting with a polyisocyanate. Long chain aliphatic groups that are part of the polyethylene oxide include polymers capped with a (C₁₀ to C₂₄) alkoxy group such as stearoxy, myristoxy, and the like. Examples of polymers include TOMADOL™ 45-13 (a polymer containing 13 ethylene oxide units reacted with a linear C₁₄-C₁₅ alcohol), TOMADOL™ 25-12 (a polymer containing 12 ethylene oxide units reacted with a linear C₁₂-C₁₅ alcohol) and TOMADOL™ 1-9 (a polymer containing 9 ethylene oxide units reacted with a linear C₁₁ alcohol) available from Tomah Products, Milton, Wis.

Long chain aliphatic groups that are incorporated into the urethane structure through a functional group include a (C₁₂ to C₂₄) alcohol such as stearyl alcohol, myristyl alcohol, and the like. The long chain portion of the alcohol is typically a hydrocarbon but can include one or more heteroatoms such as oxygen, sulfur or nitrogen interrupting the carbon chain that do not provide additional sites capable of reacting with a polyisocyanate. Examples include esters, ethers, substituted amines and the like.

In one preferred embodiment, the urethane is the reaction product of a triisocyanate, an alkoxy capped polyethylene oxide, preferably methoxy capped, with one reactive hydroxy group, and a long chain alcohol, for example stearyl alcohol. The long chain alcohol is added to produce a urethane with a weighted average HLB value in the range of about 1 to about 11.

Another aspect of this embodiment provides a urethane composition comprising a long chain alcohol/ethylene oxide urethane in combination with other additives. The ratio of polyethylene oxide urethane to additive is preferably from 1:1 to 10:1.

A wide variety of compounds may be used as additives with the urethane including, for example, sulfonated aromatic polymers, polymers derived from one or more α- and/or β-substituted acrylic acid monomers, hydrolyzed copolymers formed from the reaction of one or more ethylenically unsaturated monomers with maleic anhydride, or a combination thereof Additives can be polymeric or copolymeric blends and can be prepared by polymerizing one or more of the monomers in the presence of one or more of the polymers.

One example of an additive is a sulfonated aromatic polymer. Sulfonated aromatic polymers include, for example, condensation polymers formed by reacting an aldehyde with a sulfonated aromatic compound and condensation polymers formed by reacting an aldehyde with an aromatic compound followed by sulfonation of the resulting polymer. Aldehydes can include formaldehyde, acetaldehyde, and the like. Suitable sulfonated aromatic compounds include, for example, compounds with hydroxy functionality such as bis(hydroxyphenyl sulfone), hydroxybenzenesulfonic acid, hydroxynaphthalenesulfonic acid, sulfonated 4,4′-dihydroxydiphenylsulfone, and blends thereof. Additionally, sulfonated aromatic compounds can include sulfonated aromatic polymers or copolymers. A copolymer can be formed, for example, between an ethylenically unsaturated aromatic monomer such as styrene and a sulfonated ethylenically unsaturated aromatic monomer such as styrene sulfonate. Applicable sulfonated aromatic polymers are further described in U.S. Pat. No. 4,680,212 (Blyth et al.), U.S. Pat. No. 4,875,901 (Payet et al.), U.S. Pat. No. 4,940,757 (Moss, III et al.), U.S. Pat. No. 5,061,763 (Moss, III et al.), U.S. Pat. No. 5,074,883 (Wang), and U.S. Pat. No. 5,098,774 (Chang).

Commercially available sulfonated aromatic condensation polymers include, for example, Erional™ NW (a polymer formed from the reaction product of naphthalene sulfonic acid, formaldehyde, and 4,4′-dihydroxydiphenylsulfone available from Ciba Specialty Chemicals Company, Tarrytown, N.Y.), Erional™ PA (a polymer formed by reacting phenol sulfonic acid, formaldehyde, and 4,4′ dihydroxydiphenyl sulfone available from from Ciba Specialty Chemicals Company), Tamol™ SN (a sodium salt of a naphthalene-formaldehyde condensate available from Rohm & Haas Co., Philadelphia, Pa.), Mesitol™ NBS (a fixation agent for anionic direct dyestuffs available from Bayer Corporation, Pittsburgh, Pa.), Bayprotect CL or CSD™, Nylofixan™ P (a formaldehyde condensation copolymer of 4,4′-dihydroxydiphenylsulfone and 2,4-dimethylbenzenesulfonic acid available from Clariant Corp., Charlotte, N.C.), and Intratex™ N (an auxiliary textile agent available from Crompton & Knowles Corp., Stamford, Conn.). The sulfonated aromatic polymers are typically sold commercially as aqueous solutions with 30 to 40 weight percent solids based on the weight of the solutions. The solutions can contain other compounds such as aromatic sulfonic acids and glycols.

In another similar example, the sulfonated aromatic polymeric additive contains a small amount of a divalent metal salt in addition to the polymeric materials. Divalent metal salts can include calcium salts, magnesium salts, and the like. The concentration of the divalent salt is typically less than about 0.1 weight percent and preferably less than about 0.05 weight percent based on the weight of the backing. The use of divalent metal salts is further described in U.S. Pat. No. 5,098,774 (Chang), incorporated herein by reference.

A second class of additives that can be used with the urethane includes polymers derived from acrylic acid or one or more α- and/or β-substituted acrylic acid monomers. These monomers typically have the general structure HR¹C═C(R)COOX wherein R and R¹ are independently selected from hydrogen, organic radicals, or halogens. X is independently selected from hydrogen, organic radicals, or cations. A preferred group of compounds of this class of additives are acrylic polymers such as, for example, polyacrylic acid, copolymers of acrylic acid with one or more other monomers that are copolymerizable with acrylic acid, or blends of polyacrylic acid with one or more acrylic acid copolymers. More preferred polymers are methacrylic polymers such as, for example, polymethacrylic acid, copolymers of methacrylic acid with one or more other monomers that are copolymerizable with methacrylic acid, or blends of polymethacrylic acid with one or more methacrylic acid copolymers. Monomers useful for copolymerization with either the acrylic acid or the methacrylic acid typically have ethylenic unsaturation such as ethyl acrylate, butyl acrylate, itaconic acid, styrene, sodium sulfostyrene, sulfated castor oil, and the like. Blends of these monomers can be used in copolymerization reactions. Commercially available acrylic include Acrysol™ from Rohm and Haas Co. (Philadelphia, Pa.) and Carbopol™ from B. F. Goodrich (Brecksville, Ohio). Commercially available methacrylic polymers include the Leukotan™ family of materials such as Leukotan™ 970, Leukotan™ 1027, Leukotan™ 1028, or Leukotan™ QR1083 available from Rohm and Haas Co. Polymers of α-and/or β-substituted acrylic acid monomers useful in compositions of this embodiment are further described in U.S. Pat. No. 4,937,123 (Chang et al.), U.S. Pat. No. 5,074,883 (Wang), U.S. Pat. No. 5,212,272 (Sargent et al.), and U.S. Pat. No. 5,744,201 (Chang et al.). A preferred acrylic polymer additive is made as disclosed in U.S. 5,744,201 (Chang et al.), col. 9, line 62 to col. 10, line 9. These patents are incorporated herein by reference.

A third class of additive polymers that can be used with the urethane includes hydrolyzed copolymers formed by the reaction of one or more ethylenically unsaturated monomers with maleic anhydride. The ethylenically unsaturated monomers typically include alpha-olefins, alkyl vinyl ethers, aromatic compounds such as styrene, and the like. Suitable alpha-olefins can include, for example, 1-alkenes containing about 4 to about 12 carbon atoms such as isobutylene, 1-butene, 1-hexene, 1-octene, 1-decene, 1-dodecene, and the like. Preferably, the alpha-olefins are isobutylene or 1-octene. A portion of the alpha-olefins can be replaced by one or more other monomers. The additive can contain up to about 50 weight percent of (C₁ to C₄) alkyl acrylates, (C₁ to C₄) alkyl methacrylates, vinyl sulfides, N-vinyl pyrrolidone, acrylonitrile, acrylamide, and the like. Mixtures of these replacements monomers can be used. Hydrolyzed copolymers formed by reacting one or more alpha-olefin monomers with maleic anhydride are further described in U.S. Pat. No. 5,460,887 (Pechhold). U.S. Pat. No. 5,001,004 (Fitzgerald et al.) further describes hydrolyzed copolymers formed by reacting one or more ethylenically unsaturated aromatic monomers with maleic anhydride. These patents are incorporated herein by reference.

Another class of additives are water-soluble or water-dispersible compounds that include, for example, methacrylic ester polymers such as ethyl methacrylate/methyl methacrylate copolymers; colloidal alumina such as CATAPAL™ and DISPAL™ aluminas available from Condea Vista Co., Houston, Tex.; colloidal silica such as NALCO™ silicas available from Nalco Chemical Co., Naperville, Ill.; silsesquioxanes such as those disclosed in U.S. Pat. Nos. 4,781,844 (Kortmann et al.), 4,351,736 (Steinberger et al.), 5,073,442 (Knowlton et al.) and 3,493,424 (Mohrlok et al.), each of which is incorporated herein by reference; polyvinylpyrrolidone; and water-soluble condensation polymers formed by the reaction of formaldehyde with urea, melamine, benzoguanamine, or acetylguanamine.

The urethane compositions are typically made water-dispersible by methods well known to persons skilled in the art. Techniques for emulsifying the compositions include sonication, shear, incorporating internal emulsifiers, and the like.

### Ethylene Co-Polymer Supported Urethanes

A second class of suitable urethanes include a polymer having an ethylene-containing (e.g., vinyl-derived) backbone with substituents attached thereto. Such urethanes can be used as release coatings on adhesive tapes, and they are known as low adhesion backsize urethanes. The polymer comprises repeat units of the following formula:

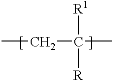

wherein in the polymer each R¹ is independently selected from the group of hydrogen and an aliphatic group (preferably having 1 to 4 carbon atoms); and wherein each R is independently selected from the group of X, which can be hydrogen, a halide, or an organic group optionally containing heteroatoms or functional groups; a urethane linked nitrogen bonded hydrocarbon group, such as that shown by the following structure:

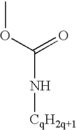

wherein q is about from between 5 and 24, preferably from between 14 and 24; and an oxygen linked water solubilizing group, such as that shown by the following structure:

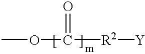

wherein each R² is independently a divalent organic linking group (preferably having 1 to 20 carbon atoms), which includes aromatic groups and optionally heteroatoms or functional groups within the organic group, m is 0 or 1, and each Y is independently a functionality capable of being ionized or is the ionized form thereof, with the proviso that the polymer contains at least one each of the urethane linked nitrogen bonded hydrocarbon group and the oxygen bonded water solubilizing group.

As used in this embodiment, the terms “organic group” and “organic linking group” mean a hydrocarbon group that is classified as an aliphatic group, cyclic group, or combination of aliphatic and cyclic groups (e.g., alkaryl and aralkyl groups). In the context of the present embodiment, the term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups, for example C₅ to C₇ alicyclic groups. The term “aromatic group” or “aryl group” means a mono- or polynuclear aromatic hydrocarbon group, for example phenyl or naphthyl. Such organic groups or organic linking groups, as used herein, include heteroatoms (e.g., O, N, or S atoms), as well as functional groups (e.g., carbonyl groups).

Preferably, each X moiety is independently selected from the group of hydrogen; a hydroxyl group; a halide; an alkylene, an alkenylene, an alkynylene, an arylene group, or mixture thereof, having a terminal hydroxyl group (preferably having 1 to 10 carbon atoms);

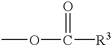

—O—R⁴ ; and —R⁵ ; wherein each R³, R⁴, and R⁵ is independently selected from the group of an aliphatic group, an aromatic group, and mixtures thereof, optionally containing heteroatoms or functional groups. Preferably, each R³, R⁴, and R⁵ independently has 1 to 20 carbon atoms.

Because each Y moiety is independently a functionality capable of being ionized or is the ionized form thereof, the polymer is capable of being dissolved or dispersed in water. Accordingly, a polymer of the present embodiment preferably contains the following units:

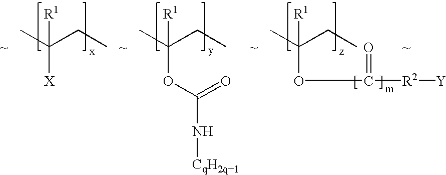

wherein each R¹ is independently selected from the group of hydrogen and an aliphatic group (preferably having 1 to 4 carbon atoms), each X is independently selected from the group of hydrogen; a hydroxyl group; a halide; an alkylene, an alkenylene, an arylene group, or mixture thereof, having a terminal hydroxyl group;

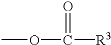

—O—R⁴; and —R⁵; wherein each R³, R⁴, and R⁵ is independently selected from the group of an aliphatic group, an aromatic group and mixtures thereof; and wherein each R² is independently a divalent organic linking group; m is 0 or 1; q is about 5 or more; and each Y is independently a functionality capable of being ionized or the ioinized form thereof Thus, each Y is independently capable upon neutralization of dispersing (preferably, solubilizing) the polymer in water. The relative proportion of the units in a polymer according to the present embodiment is as follows: x is about 0 to about 70; y is about 5 to about 95; and z is about 5 to about 50; wherein x, y and z each represent mole percent.

As stated above, the water solubilizing group contains a functionality, labeled Y, that is capable of being ionized (such as an acidic group) or is the ionic form thereof that may be anionic or cationic. Examples of suitable anionic groups, which may be formed from acidic groups, include an anion selected from the group of —OSO₂ O⁻, —SO₂ O⁻, —CO₂⁻, (—O)₂ P(O)O⁻; —OP(O)(O⁻)₂, —P(O)(O⁻)₂, —P(O⁻)₂, and —PO(O⁻)₂. Examples of suitable cationic groups include organo-ammonium groups that include a cation selected from the group of —NH(R⁸)₂⁺ and —N(R⁸)₃⁺, wherein R⁸ is selected from the group of a phenyl group; a cycloaliphatic group; and a straight or branched aliphatic group having about 1 to about 12 carbon atoms. Preferably, R⁸ is a lower alkyl group of about 1 to about 4 carbon atoms.

The coating compositions of this embodiment are capable of being dispersed and coated out of water, although they can also be dispersed and coated out of organic solvents or mixtures of organic solvents and water. As used herein, a “water dispersible” composition includes within its scope a composition that is only dispersible, partially soluble, or readily soluble in water.

A polymer according to this embodiment includes a backbone of repeating ethylene containing (e.g., vinyl-derived) units having substituents attached thereto, as shown above. Such a polymer can be made by a variety of known methods. Preferably, it is made by modifying the polymeric backbone component by adding isocyanate-containing hydrocarbons and water solubilizing groups, both as shown above. For example, a polymeric backbone component preferably includes repeating ethylene containing units, such as a polyethylene, wherein the polymer has at least one pendant hydroxyl group attached thereto. This can be either purchased or prepared from smaller units (i.e., precursors).

For example, the polymeric backbone can be formed from one or more precursors including, but not limited to, the group of ethylene, vinyl halides (e.g., vinylidene chloride), vinyl ethers (e.g., vinyl propyl ether), vinyl esters (e.g., vinyl acetate), acrylic esters (e.g., methyl acrylate), methacrylic esters (e.g., ethyl methacrylate), acids such as acrylic acid and methacrylic acid, amides (e.g., acrylamide), aromatic vinyl compounds (e.g., styrene), heterocyclic vinyl monomers, allyl compounds, esters and half esters of diacids (e.g., diethyl maleate), and mixtures thereof Of these, those that do not contain acrylate groups are the more preferred.

Preferred polymeric backbone components are prepared from polymerizing and copolymerizing vinyl esters to afford, for example, polyvinyl acetate and ethylene/vinyl acetate copolymer, both fully or partially hydrolyzed, to form a polyvinyl alcohol. Some commercially available materials may retain acetate groups. These materials are also referred to herein as vinyl-derived and are preferably non-acrylate derived.

Accordingly, a preferred backbone unit, prior to modification by an isocyanate containing hydrocarbon and a water solubilizing compound, in a polymer according to this embodiment has the formula:

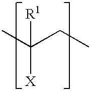

wherein in the polymer each R¹ is independently selected from the group of hydrogen and an aliphatic group. Each X moiety is preferably independently selected from the group of hydrogen; a hydroxyl group; a halide; an alkylene, an alkenylene, an alkynylene, an arylene group, or mixtures thereof, having a terminal hydroxyl group;

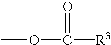

—O—R⁴ ; and —R⁵ ; wherein each R³, R⁴, and R5 are independently selected from the group of an aliphatic group, an aromatic group, and mixtures thereof, with the proviso that at least one of the X substituents on the polymeric backbone is a hydroxyl group (prior to modification). It will be understood by one of skill in the art that because each R¹ and X groups is independently selected from the above lists, the polymeric backbone component (prior to modification) may contain more than one type of unit. This is also true for the polymer according to this embodiment. One skilled in the art will further recognize that if X contains an alkylene, an alkenylene, an alkynylene group, an arylene group, or mixtures thereof having a terminal hydroxyl group, then that is the point of modification, and the resultant polymer will have a respective intervening group between the backbone and oxygen link.

As mentioned above, a composition according to this embodiment includes a polymer formed from modification of an ethylene-containing, preferably a vinyl-derived, backbone, as described above, with certain isocyanate-containing hydrocarbons. These hydrocarbons are also referred to herein as “hydrocarbon isocyanates.” For example, reaction of a polyvinyl alcohol with an isocyanate results in the modification of hydroxyl groups on the backbone to urethane (or carbamate) groups. Preferably, the urethane links long side chain hydrocarbons which terminate with methyl groups.

Preferably, these isocyanate-containing hydrocarbons are capable of forming urethane linked nitrogen-bonded hydrocarbon side chains having more than about 5 carbon atoms in length and a terminal methyl group. More preferably, the nitrogen bonded hydrocarbon side chains have at least about 12 carbon atoms, even more preferably at least about 14 and, most preferably, at least about 16 carbon atoms in length The length of the hydrocarbon side chain affects the melting point of the polymer prepared therefrom, as taught by Dahlquist et al. (See e.g., U.S. Pat. No. 2,532,011, incorporated herein by reference.) If the length of the hydrocarbon side chain is too short, i.e., less than about 5, the long chain monomer does not crystallize at room temperature.

Typically, hydrocarbon isocyanates have the general formula:

(C_{q}H_{2q+1})N═C═O

where q preferably has a value of more than about 5, more preferably, at least about 12, even more preferably at least about 14, and most preferably, at least about 16. One preferred hydrocarbon isocyanate for use in the present embodiment has the formula:

C₁₈H₃₇N═C═O

(octadecyl isocyanate) which has 18 carbons in the nitrogen-linked alkyl chain. When, for example, this is reacted with polyvinyl acetate (partially or fully hydrolyzed), the resulting N-octadecyl carbamate side chains have the structure indicated by the formula:

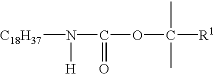

where the carbon atom at the extreme right is one of those in the backbone, wherein each R¹ is independently hydrogen or an aliphatic group. The nitrogen-linked group need not be a continuous aliphatic hydrocarbon chain, and may include other atoms or radicals capable of being present in the isocyanates, provided that they do not interfere with the desired properties of the polymer formed therefrom and that they permit a nitrogen-linked side chain which terminates with an alkyl group more than 5 carbon atoms in length having a terminal methyl group.

Accordingly, one preferred unit in a polymer of the present embodiment having a urethane linked nitrogen-bonded hydrocarbon side chain having about 5 carbon atoms or more in length and a terminal methyl group attached thereto is:

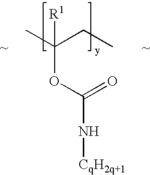

wherein q is about from between 5 to 24, preferably from between 14 to 24, each R¹ is independently selected from the group of hydrogen and an aliphatic group and y is about 5 to about 95 mole percent of the polymer.

Water solubilizing groups preferably include functionalities capable of being ionized or are the ionic form thereof. These water solubilizing groups are hydrophilic so that when present in the polymer, they assist in solubility or dispersibility of the polymer in water and likely enhance the stability of aqueous water dispersions of the polymer. Typically, urethanes with long hydrocarbon side chains are hydrophobic and not readily water dispersible. Thus, a water solubilizing group may be incorporated in a polymer, in a nonionized form, that subsequently ionizes with the addition of a salt forming compound allowing the polymer to be dispersed in water.

It is preferred to incorporate such water solubilizing groups into a polymer in accordance with this embodiment by means of a water solubilizing compound. “Water solubilizing compound” refers to a compound that has a water solubilizing group, as defined above, and is capable of being attached to the polymeric backbone via an oxygen linkage, preferably an ester linkage. Therefore, a water solubilizing compound may have the water solubilizing group in an ionized or a nonionized form. For example, a carboxylic acid group is an acidic water solubulizing group that can be ionized by salt formation, for instance, by reaction with a base.

The water solubilizing groups preferably are derivatives of carboxylic acids and more preferably, derivatives of cyclic anhydrides. Most preferred water solubilizing groups may include aromatic moieties or alkyl chains that may be saturated or unsaturated, and linear or branched. Examples of preferred water solubilizing compounds that form water solubilizing groups, when attached to the polymer backbone, are succinic anhydride, maleic anhydride, glutaric anhydride, phthalic anhydride, and 2-sulfobenzoic acid cyclic anhydride. Other water solubilizing compounds include those capable of reacting with the polymeric backbone component to form pendant water solubilizing groups such as halo-alkyl acids, e.g. chloroacetic acid. It is believed that the functionality on the polymer, preferably an ester linked acid group, is important for water dispersibility of the polymer because it can be neutralized by a base.

As mentioned above, water dispersibility of the polymer is preferably accomplished by ionization of the water solubilizing group, preferably by the formation of a salt by the water solubilizing group. That is, the nonionized form of the water solubilizing group is soluble in an organic solvent (such as toluene) while the salt (or ionized) form of the water solubilizing group is dispersible in water. Thus, a salt forming compound is preferably selected from the group of organic bases and inorganic bases. One suitable class of an organic base includes a tertiary amine compound. Suitable inorganic bases include hydroxides or carbonates of alkali metals (e.g., potassium hydroxide). More preferably, a salt forming compound is selected from the group of ammonia, ammonium hydroxide, trimethylamine, triethylamine, dimethylethanolamine, tripropylamine, triisopropylamine, tributylamine, triethanolamine, diethanolalamine, and mixtures thereof. Triethylamine is a preferred salt forming compound.

Accordingly, another preferred unit in a polymer of the present embodiment having a water solubilizing group attached thereto is:

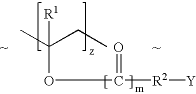

wherein each R¹ is independently selected from the group of hydrogen or an aliphatic group, each R² is independently a divalent organic linking group, m is 0 or 1, each Y is independently a functionality capable of being ionized or the ionic form thereof, and z is about 5 to about 50 mole percent of the polymer.

Other compounds, or additives, may be added to compositions including the polymer according to this embodiment to enhance or obtain particular properties. Optional additives are preferably selected from the group of a crosslinker; a defoamer; a flow and leveling agent; a colorant (e.g., a dye or a pigment); an adhesion promoter for use with certain substrates; a plasticizer, a thixotropic agent; a rheology modifier; a film former (e.g., a coalescing organic solvent to assist in film formation); a biocide/anti-fungal agent; a corrosion inhibitor; an antioxidant; a photostabilizer (UV absorber); and a surfactant/emulsifier; and an extender (e.g., polymeric emulsion, thickener, filler); and mixtures thereof Suitable bases, for example ammonium hydroxide, can also be optionally used as additives in order to control the pH of the composition, preferably maintaining a pH above 6.5.

Particularly useful optional additives from the group of extenders include thickeners (also referred to as wetting agents) that can be added to a urethane composition of the present embodiment as a cost savings measure and can be present in a composition in an amount that does not significantly adversely affect properties of a urethane composition so formed. Thickeners are usually cellulosic ethers that typically act by immobilization of water molecules and, consequently, can be added to increase the dispersion viscosity. Increase in dispersion viscosity is generally a function of thickener concentration, degree of polymerization, and chemical composition. An example of a suitable commercially available thickener is available under the trade designation NATROSOL from Aqualon Company, Wilmington, Del. A subset of thickeners include associative thickeners that can be added to increase viscosity. Associative thickeners typically have a hydrophilic and a hydrophobic portion in each molecule. It is believed that preferential interaction of these portions with themselves and with the polymer according to this embodiment form a three dimensional network structure within the dispersion. An example of a suitable commercially available associative thickener is available under the trade designation RHEOVIS CR2 from Allied Colloids, Suffolk Va.

Other useful optional additives from the group of extenders can be in the form of polymeric emulsions. An example of suitable commercially available polymer emulsion includes a vinyl acetate/ethylene copolymer emulsion from Air Products, Inc., Allentown, Pa.

Typically, conventional water-borne urethane compositions include a surfactant/emulsifier to stabilize the emulsion dispersion during polymerization and prior to coating. (See e.g., U.S. Pat. No. 5,225,480 to Tseng et al. and U.S. Pat. No. 5,516,865 to Urquiola, incorporated herein by reference.) However, a composition of the present embodiment is formed from a polymer that includes a water solubilizing group that is preferably a salt, as described above. In this instance, the composition is preferably substantially surfactant-free. That is, a preferred composition of this embodiment can include less than about 0.5 weight percent, more preferably less than about 0.05 weight percent, of a surfactant for the purpose of stabilizing the emulsion dispersion during polymerization. Advantageously, it has been found that by modifying the polymer with an ionized form of a water solubilizing group, a surfactant is not required for either the formation of the polymer or to enhance the stability of the polymer for producing a water bome coating. This is significant because in certain situations, it has been found that coatings formed from compositions including a surfactant may have a surfactant residue on an exposed surface, which may interfere with the properties of the coating.

The polymer of the present embodiment can be coated out of an organic solvent, water, or mixtures thereof (i.e., a carrier solvent). Preferably, it is coated out of water. Thus, compositions including a polymer in accordance with this embodiment may include an organic solvent when it is desired to coat the urethanecomposition from an organic solvent, such as aromatic hydrocarbons (e.g., toluene and xylene); esters (e.g., ethyl acetate); aliphatic hydrocarbons (e.g., heptane and hexane); alcohols (e.g., isopropanol and n-butanol); ketones (e.g., acetone and methyl ethyl ketone); and mixtures thereof. Other organic solvents that may be included are residual reaction solvents from the synthesis of the polymer, which include, preferably, N-methyl-2-pyrrolidinone, dimethylformamide, diglyme, and mixtures thereof.

A urethane composition of this embodiment is preferably prepared by a method that includes admixing a polymeric backbone component with an isocyanate hydrocarbon and a water solubilizing compound, and inverting (or ionizing the nonionized form of a water solubilizing group) so that the composition can be applied from an aqueous dispersion, although this need not be done if coating from an organic solvent. Typically, an admixture of a polymeric backbone component and at least one organic solvent are charged into a suitable reaction vessel. Preferred organic solvents include an aromatic hydrocarbon, N-methyl-2-pyrrolidinone, dimethylformamide, diglyme, and a mixture thereof. Examples of suitable aromatic hydrocarbon solvents include toluene and xylene. This admixture is dewatered via azeotropic distillation and then allowed to react with an isocyanate containing hydrocarbon, commonly at an elevated temperature of about 70° C. to about 140° C. until the isocyanate containing hydrocarbon is consumed, about 0.2 hour to about 12 hours. A water solubilizing compound, as defined above, is then added at an elevated temperature of about 70° C. to about 140° C. until consumption of the water solubilizing compound (about 1 hour to about 12 hours). The resulting polymer may now be used in a composition with optional additives, if it is desirable to coat the composition out of an organic solvent.

When the urethane composition is to be applied from an aqueous dispersion, it is converted to a water dispersible derivative thereof. Typically, this is accomplished by addition of a salt forming compound to the organic solvent dispersed polymer. A convenient method for providing an aqueous dispersion of a polymer according to this embodiment is to add the polymer to a mixture of an organic solvent (e.g., isopropanol), water, and a salt forming compound. The organic solvent can then be removed by distillation, for example, in a sufficient amount to form an aqueous dispersion of the polymer. While not wishing to be bound by any particular theory, it is believed that the salt forming compound neutralizes (or ionizes) the nonionized form of the water solubilizing group so as to “invert” the polymer to become water dispersible. It is further believed that the polymer remains as its inverted (or ionized) form dispersed in water, and then may revert to its original state (i.e., the water solubilizing group is in an acidic form) as the urethane composition dries on a substrate surface. Accordingly, there is no need to add surfactants/emulsifiers to achieve a stable aqueous dispersion of the polymer.

A urethane composition according to this embodiment may be clear, and is believed to be a solution, so that a substantially uniform film may be formed by coating at room temperature. However, a urethane composition according to this embodiment may be cloudy or opaque, wherein application of heat is required to coalesce particles of the composition so that a substantially uniform film is formed.

Yet another preferred coating material of this embodiment is a polyurethane material formed by reaction of a hydrolyzed polyvinylacetate, i.e. a polyvinyl alcohol, with an alkyl isocyanate and a dicarboxylic acid or an anhydride thereof. As an example, a commercially available, 98% hydrolyzed polyvinyl acetate (AIRVOL™ 103) is reacted with octadecyl isocyanate and anhydride. The mole percentage of the different groups attached to the polyvinyl alcohol is controlled by the mole ratio of the reactants used. As the PVA starting material still bears 2% acetate groups, the product contains 2% acetate groups. It is preferred that the amount of the isocyanate and the amount of the acid or anhydride shall be less than the remaining 98%, so that the product contains some free hydroxyl groups. It is also preferred that the amount of isocyanate shall exceed the amount of dicarboxylic acid or anhydride, so that in the product the number of urethane moieties exceeds the number of dibasic acid-ester moieties. One particularly preferred polyurethane material is based on polyvinyl alcohol, 17 mole % of whose hydroxyl groups remains as such, 2 mole % of which are acetate moieties remaining after the 98% hydrolyses of the PVA, 68 mole % of which are converted to moieties and 13% are converted to carboxyalkylcarbonyloxy groups (HOOC(CH₂)₃ COO—), derived from glutaric anhydride. This polyurethane product can be dispersed in water, suitably in the form of a salt with an amine, especially a C₁-C₄ trialkylamine, of which triethylamine is preferred. The dispersion applied to the abrasive article by roll coating, spraying, dipping, casting, or any suitable method.

It will be appreciated that octadecyl isocyanate and glutaric acid are mentioned by way of example but other reactants can be used. For example any C₁₂-C₂₄ alkyl isocyanate can be used and the dicarboxylic acid or anhydride can be of formula

HOOC(CH₂)ₙCOOH

wherein n is an integer from 3 to 6, or the corresponding anhydride.

The invention is further illustrated, by way of example, with reference to the accompanying drawings of which:

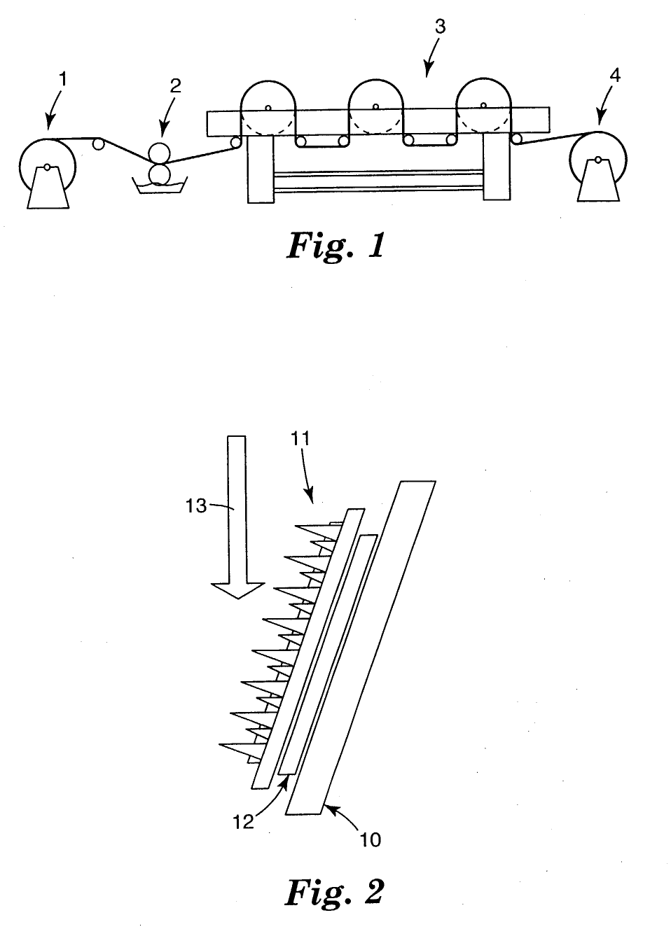

FIG. 1 shows schematically an apparatus for coating and drying treated material, and

FIG. 2 shows an apparatus for testing material for dimensional and conformational stability.

Referring to FIG. 1, there is shown a Back-Treater-Flexer, or BTF, which is used to treated formed sheets of abrasive to reduce or eliminate memory effects in the sheets, which BTF has been modified to apply urethane material in accordance with the invention. Abrasive sheets are initially in large sheets that are formed into rolls, called jumbos, and subsequently jumbos are cut to required sizes. Although the size of jumbos can vary, a typical jumbo might be 60 inches (1.52 m) wide by 500 yards (457.2 m) long.

FIG. 1 shows schematically an unwind station 1 where a jumbo roll is unwound. The unwound material is then passed to a coating station 2 where it passes between two rolls, one of which rolls passes it rotates through a bath containing the coating to be applied, so that the lower roll transfers the urethane material and liquid vehicle onto one surface of the abrasive sheet material. Thereafter the sheet passes over a number, in this instance three, steam cans 3 where drying is effected. The abrasive sheet is rewound into the jumbo at rewind station 4.

FIG. 2 shows schematically an apparatus used to test abrasive sheets for cupping when the sheets are exposed to water. A plastic board 10 is held at an angle a that is 30 degrees or less to the vertical. A test piece 11 of the abrasive sheet is secured to the plastic board by means of a piece 12, approximately 2″×8″ (5.1×20.3 cm), of 3M SCOTCH™ #410 D/C tape, available from 3M Company, St. Paul, Minn., applied to the center of the back side of the test piece. The test piece is 5″ (12.7 cm) in web direction and 9″ (22.9 cm) in the machine direction. A stream of water at a temperature in the range approximately 14 to 20° C. and at a flow rate of approximately 1200 ml per minute falls in the direction shown by arrow 13 onto that side of the abrasive material that bears the abrasive grains. This is continued for one hour. The extent of cupping of the test piece is then determined by measuring the distance between the plastic board 10 and the edge of the test piece 11. In the following examples results are given in terms of mm of cup after one hour of exposure to water.

### EXAMPLE 1

Tests were carried out on an abrasive sheet article composed of a cloth polyester backing, abrasive grains of silicon carbide and a phenolic binder, commercially available from 3M Company under the designation 461F. The abrasive sheet articles were flexed twice at a 45° angle, in opposite directions, and once at 90° by passing them over a rolling mechanism. The abrasive article was treated with a urethane material obtained by the reaction of a triisocyanate of the formula:

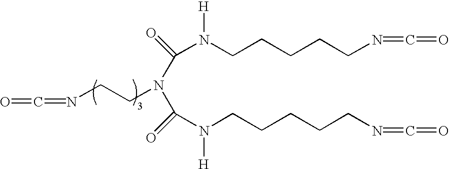

of a methoxy-capped ethylene oxide alcohol of the formula:

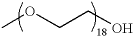

and of stearyl alcohol, in the equivalence ratio of 1:0.15:0.85 (triisocyanate:ethylene oxide alcohol:stearyl alcohol) to yield a urethane mixture, in which the two major urethane components have the formula:

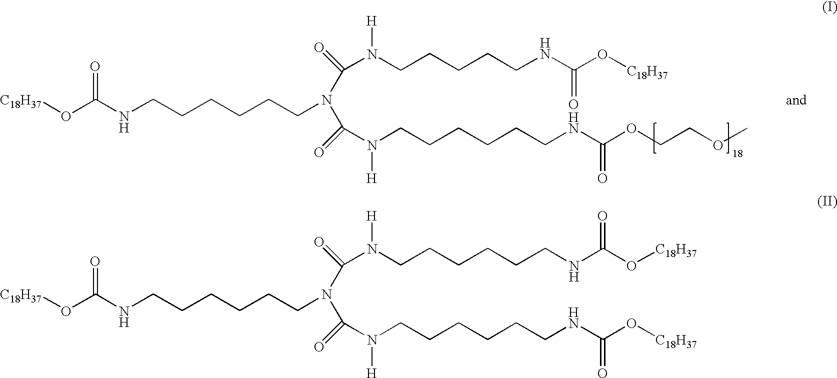

in an approximate ratio of 1:1.2 (I:II). The urethane bearing materials were dispersed in solution with ammonium hydroxide, to adjust the pH to 9, and with an acrylate polymer that was prepared as disclosed in U.S. Pat. No. 5,744,201 (Chang et al.), col. 9, line 62-col. 10, line 9. The solution had a solids content of 2.4%. The weight ratio of the three components was approximately 28.9:6.0:1.0 (urethane:acrylate:ammonium hydroxide). The roll coating was performed using laboratory apparatus, 12″ (30.5 cm) wide with a line speed of 15 ft. (4.57 m) per minute. A 5″×9″ (12.7×22.9 cm) belt was coated, and the treated material was laid on the floor to dry for two hours before being subjected to the test described with reference to FIG. 2. The amount of material deposited (dry) was 1.07 g/m². Results were compared with an untreated abrasive material. It was found that the untreated material showed a curl of 10 mm after 1 hour, whereas the curl of the treated material was less than 1 mm after one hour.

### EXAMPLE 2

Tests were made on abrasive material made to the same specification as the material of Example 1, but made at a different location. It has been found that the material of Example 2 is consistently more flexible than that of Example 1, possibly owing to the different ambient conditions under which the materials are made, especially humidity. The urethane material was the same as used in Example 1, and was applied using the same apparatus as in Example 1. Line speed was 30 ft/min (9.14 m/min), and two concentrations of urethane dispersions were used, namely 4.4% solids and 2.6% solids. The material treated with the 4.4% solids composition was dried by passing over two steam cans, the material being in contact with each steam can for 10 seconds, for a total of 20 seconds. The temperature of the material in contact with the steam cans was 140° F. (60° C.). The material treated with the 2.6% solids composition was dried over three steam cans, for a total drying time of 30 seconds. The material in contact with the first steam can had a temperature of 110° F. (43.3° C.) and when in contact with the second and third it had a temperature of 158° F. (70° C.). These applications were calculated to yield a deposition of solids (dry) of 1.96 g/m² and 1.16 g/m² respectively. The treated materials were tested using the apparatus of FIG. 2, and compared with untreated material. It was found that the untreated material showed a curl of 8 mm after one hour, the material treated with 4.4% solids composition showed a curl of 5 mm after one hour and that treated with 2.6% solids showed a curl of only 2 mm after one hour.

### EXAMPLE 3

Various specimens, 5″×9″ (12.7×22.9 cm), of the same abrasive material as used in Example 2 were subjected to application of different urethane materials. Some articles (Ex. 3-2) were coated with a polyethylene oxide urethane material as described in Example 1, while others (Ex. 3-3) were coated with an ethylene co-polymer supported urethane material, using the same rolling method as described in Example 1. The ethylene co-polymer supported urethane material was an aqueous dispersion of a polymer having the formula:

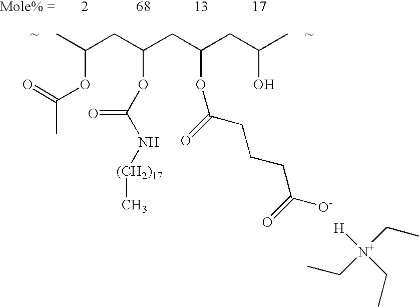

Results are given in Table 1.

### EXAMPLE 4 to 7

Various specimens, 5″×9″ (12.7×22.9 cm), of an abrasive material similar to the one used in Example 1 were subjected to the application of a urethane material on the side of the backing that bore the abrasive grains (top) or the opposite cloth (back) side. Some specimens were treated without the flexing described in Example 1. Results are given in Table 1.

TABLE 1

| Example | Material Information | | | | dry coat wt. | Coating | curl test | water absorb |
|---|---|---|---|---|---|---|---|---|
| ID | Flex | Grade | Side | Solution | (g/sq. m) | method | (mm at 1 hr) | (g at 1 hr) |
| 1-1 | Flexed | P120 | Back | None | 0 | n/a | 10 | n/a |
| 1-2 | Flexed | P120 | Back | Wax-U | 1.07 | roll | <1 | n/a |
| 2-1 | Flexed | P120 | Back | None | 0 | n/a | 8 | n/a |
| 2-2 | Flexed | P120 | Back | Wax-U | 1.96 | roll | 5 | n/a |
| 2-3 | Flexed | P120 | Back | Wax-U | 1.16 | roll | 2 | n/a |
| 3-1 | Flexed | P120 | Back | None | 0 | n/a | 10 | 2.00 |
| 3-2 | Flexed | P120 | Back | Wax-U | 1.07 | roll | 5 | 1.01 |
| 3-3 | Flexed | P120 | Back | LAB-U | 0.88 | roll | 3 | 0.77 |
| 4-1 | Unflexed | P100 | Top | None | 0 | n/a | 21 | 0.97 |
| 4-2 | Unflexed | P100 | Top | Wax-U | 0.98 | roll | 8 | 0.69 |
| 4-3 | Unflexed | P100 | Top | LAB-U | 0.91 | roll | 6 | 0.55 |
| 5-1 | Unflexed | P100 | Back | None | 0 | n/a | 19 | 0.96 |
| 5-2 | Unflexed | P100 | Back | Wax-U | 0.87 | roll | 8 | 0.71 |
| 5-3 | Unflexed | P100 | Back | LAB-U | 0.80 | roll | 6 | 0.57 |
| 6-1 | Flexed | P100 | Top | None | 0 | n/a | 12 | 1.12 |
| 6-2 | Flexed | P100 | Top | Wax-U | 0.96 | roll | 5 | 0.76 |
| 6-3 | Flexed | P100 | Top | LAB-U | 0.86 | roll | 3 | 0.57 |
| 7-1 | Flexed | P100 | Back | None | 0 | n/a | 11 | 1.16 |
| 7-2 | Flexed | P100 | Back | Wax-U | 0.98 | roll | 5 | 0.81 |
| 7-3 | Flexed | P100 | Back | LAB-U | 0.94 | roll | 3 | 0.66 |

1) sample 1-1 to 1-2 are on a less flexible abrasive material (P120 grit) cut in size of 5″ × 9″ (12.7 × 22.9 cm)
2) sample 2-1 to 3-3 are on a flexible 461F abrasive material (P120 grit) cut in size of 5″ × 9″ (12.7 × 22.9 cm)
3) sample 4-1 to 7-3 is on a less flexible abrasive material (P100 grit) cut in size of 5″ × 9″ (12.7 × 22.9 cm)
4) “None” is controlled sample with no treatment
5) “Wax-U” is as described in Example 1
6) “LAB-U” is as described in Example 3

Various modifications and alterations of this invention will become apparent to those skilled in the art without departing from the scope of this invention, and it should be understood that this invention is not to be unduly limited to the illustrated embodiments set forth herein.

1. An abrasive article comprising a backing material having first and second opposed major surfaces and an abrasive layer comprising abrasive particles and binder secured to the said first major surface, the article also bearing a hydrophilic/lipophilic urethane material to enhance dimensional and conformational stability of the abrasive article, wherein the hydrophilic/lipophilic urethane material is selected from the group consisting of
a) products of reaction of a polyisocyanate, a polyethylene oxide and a long chain aliphatic alcohol, in admixture with a polymer derived from acrylic acid or an α- or β-substituted acrylic acid, and
b) polymers with an ethylene-containing backbone bearing urethane-linked nitrogen-bonded hydrocarbon groups and oxygen-linked water solubilizing groups.

2. An article according to claim 1 wherein the urethane material is applied to the abrasive layer.

3. An article according to claim 1 wherein the urethane material is applied to the second major surface.

4. An article according to claim 1 wherein the urethane material is the product of reaction of a polyisocyanate, a polyethylene oxide and a long chain aliphatic alcohol, in admixture with a polymer derived from acrylic acid or an α- or β-substituted acrylic acid.

5. An article according to claim 4 wherein the polyethylene oxide is present in a range from about 5 to about 55 weight percent based on the weight of the urethane material.

6. An article according to claim 4, wherein the polyisocyanate is a triisocyanate, the polyethylene oxide contains up to 200 ethylene oxide units and at least one hydroxy group and the long chain aliphatic alcohol has from 12 to 24 carbon atoms.

7. An article according to claim 6, wherein the urethane material comprises a urethane of structure (I).

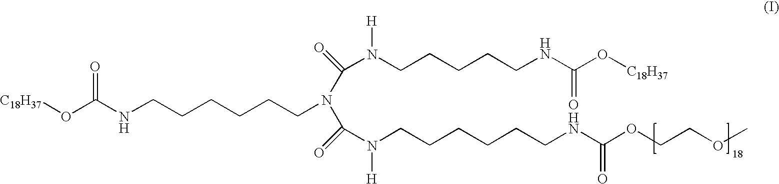

8. An article according to claim 7, wherein the urethane material is in admixture with a urethane of structure (II).

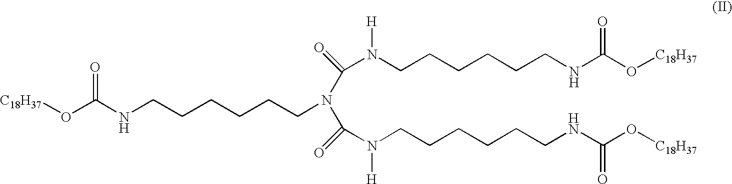

9. An article according to claim 4 wherein the weight ratio of urethane material to polymer derived from acrylic acid or an α- or β-substituted acrylic is 1:1 to 10:1.

10. An article according to claim 1 wherein the urethane material is a co-polymer with an ethylene-containing backbone bearing urethane-linked nitrogen-bonded hydrocarbon groups and oxygen-linked water solubilizing groups.

11. An article according to claim 10 wherein the polymer comprises repeating units of the following formula: 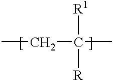
wherein in the polymer each R¹ is independently selected from the group of hydrogen and an aliphatic group; and wherein each R is independently selected from the group consisting of hydrogen, a halide, and an organic group optionally containing heteroatoms or functional groups; a urethane linked nitrogen-bonded hydrocarbon group; and an oxygen-linked water solubilizing group; with the proviso that the polymer contains at least one each of the urethane linked nitrogen-bonded hydrocarbon group and the oxygen-bonded water solubilizing group.

12. An article according to claim 11 wherein the nitrogen-bonded hydrocarbon group has the following structure: 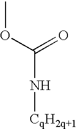
wherein q is 5 or more.

13. An article according to claim 11 wherein the oxygen-linked water solubilizing group has the following structure: 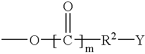
wherein each R² is independently a divalent organic linking group, m is 0 or 1, and each Y is independently a functionality capable of being ionized or is the ionized form thereof.

14. An article according to claim 11, wherein the urethane material has the structure

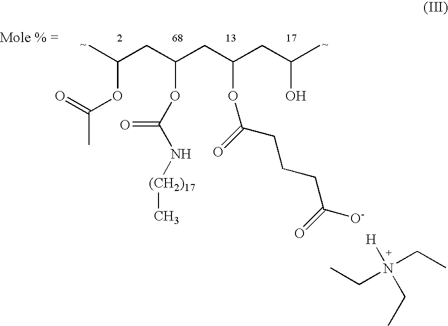

15. A process for preparing a coated abrasive article which comprises applying a hydrophilic/lipophilic urethane material onto a major surface of an abrasive article to form the coated abrasive article, wherein the urethane material is selected from the group consisting of:
a) products of reaction of a polyisocyanate, a polyethylene oxide and a long chain aliphatic alcohol, in admixture with a polymer derived from acrylic acid or an α- or β-substituted acrylic acid, and
b) a co-polymer with an ethylene-containing backbone, bearing urethane-linked nitrogen-bonded hydrocarbon groups and oxygen-linked water solubilizing groups.

16. A process for abrading an object which comprises the use of a coated abrasive article according to claim 1.

17. A process according to claim 16, wherein the object is a glass object.
